(19) United States
(12) Patent Application Publication
(10) Pub. No.: US 2018/0251352 A1
(43) Pub. Date: Sep. 6, 2018

(54) AUTOMATIC REVERSING SCREW MECHANISM FOR CABLE WINDING

(71) Applicant: Goodrich Corporation, Charlotte, NC (US)

(72) Inventors: Bejan Ijadi-Maghsoodi, Diamond Bar, CA (US); Paul Maker, Wrentham, MA (US); Zachary Limas, Diamond Bar, CA (US)

(21) Appl. No.: 15/910,807

(22) Filed: Mar. 2, 2018

Related U.S. Application Data
(60) Provisional application No. 62/466,903, filed on Mar. 3, 2017.

(51) Int. Cl. B66D 1/39; B65H 75/44; B66D 1/14; B66D 1/60; A62B 1/18

(52) U.S. Cl. CPC B66D 1/39; B65H 75/4407; A62B 1/18; B66D 1/60; B66D 1/14

(57) ABSTRACT

A level wind mechanism includes a first screw and a second screw extending through a block. A shoe is disposed within the block between the first screw and the second screw. The shoe includes a first follower for engaging with and being driven by a thread of the first screw and a second follower for engaging with and being driven by a thread of the second screw. Each thread includes cams at the terminal ends of the thread for causing the shoe to disengage from that thread and to shift to engaging the other thread. In this way, the first screw and the second screw cause the shoe, and thus the block, to translate relative to the first screw and the second screw.

### CROSS-REFERENCE TO RELATED APPLICATION(S)

This application claims the benefit of U.S. Provisional Application No. 62/466,903 filed Mar. 3, 2017 for “AUTOMATIC REVERSING SCREW MECHANISM FOR CABLE WINDING”.

### BACKGROUND

This disclosure relates generally to hoists. More particularly, this disclosure relates to translating body rescue hoists for aircraft.

Rescue hoists deploy and retrieve a cable from a cable drum to hoist persons or cargo, and the rescue hoist may be mounted to an aircraft, such as a helicopter. The rescue hoist includes a drum off of which the cable is deployed. The cable drum rotates to spool or unspool the cable from the cable drum, with one end of the cable attached to the cable drum and the other end, which can include a hook or other device, deployed during operation. The cable should be levelly wound onto the cable drum to prevent fouling of the cable and to prevent the cable from experiencing extra strain. To levelly wind the cable onto the cable drum, either the cable drum or a payout block translates during cable winding and unwinding to ensure that the cable is properly aligned on the cable drum. To ensure that the cable is levelly wound either the cable drum or the payout block is attached to and follows along a level wind mechanism, which is typically a dual-threaded screw such as a diamond screw, yankee screw, or reversing screw. Dual-threaded screws include inherently sharp features where the grooves intersect, which can fracture due to vibration leading to the follower prematurely reversing direction, causing a cable miswrap on the cable drum.

### SUMMARY

According to an aspect of the disclosure, a level wind mechanism includes a first screw, a second screw, a block through which the first screw and the second screw extend, and a shoe retained within the block between the first screw and the second screw. The first screw has a first driven end, a first distal end, and a first thread. The second screw has a second driven end, a second distal end, and a second thread. The shoe has a first follower extending from a first end of the shoe and a second follower extending from a second end of the shoe. The first follower is configured to engage with and be driven by the first thread and the second follower is configured to engage with and be driven by the second thread.

According to another aspect of the disclosure, a rescue hoist includes a cable drum rotatable about a cable drum axis, a linear bearing extending through and supporting the cable drum and configured to cause the cable drum to rotate about the cable drum axis, a stationary frame supporting the linear bearing, and a level wind mechanism configured to cause the cable drum to translate along the cable drum axis. The level wind mechanism includes a first screw, a second screw, a block through which the first screw and the second screw extend, and a shoe retained within the block between the first screw and the second screw. The first screw has a first driven end, a first distal end, and a first thread. The second screw has a second driven end, a second distal end, and a second thread. The block is mounted on an inner surface of the cable drum. The shoe has a first follower extending from a first end of the shoe and a second follower extending from a second end of the shoe. The first follower is configured to engage with and be driven by the first thread and the second follower is configured to engage with and be driven by the second thread.

### BRIEF DESCRIPTION OF THE DRAWINGS

FIG. 1A is an elevation view of an aircraft and rescue hoist.

FIG. 1B is a cross-sectional view of a rescue hoist.

FIG. 2 is a perspective view of a cable drum and level wind mechanism.

FIG. 3A is an elevation view of a level wind mechanism.

FIG. 3B is a cross-sectional view of the level wind mechanism of FIG. 3A showing a shoe in a first position.

FIG. 3C is a cross-sectional view of the level wind mechanism of FIG. 3A showing a shoe in a second position.

FIG. 4 is an enlarged view of detail Z of FIG. 3A.

FIG. 5A is a cross-sectional view of the level wind mechanism of FIG. 2 taken along line 5-5 in FIG. 2 showing a shoe in a first position.

FIG. 5B is a cross-sectional view of the level wind mechanism of FIG. 2 taken along line 5-5 in FIG. 2 showing a shoe in a second position.

FIG. 6A is a side elevation view of a shoe.

FIG. 6B is a perspective view of a shoe.

FIG. 7 is cross-sectional view of another embodiment of a level wind mechanism.

### DETAILED DESCRIPTION

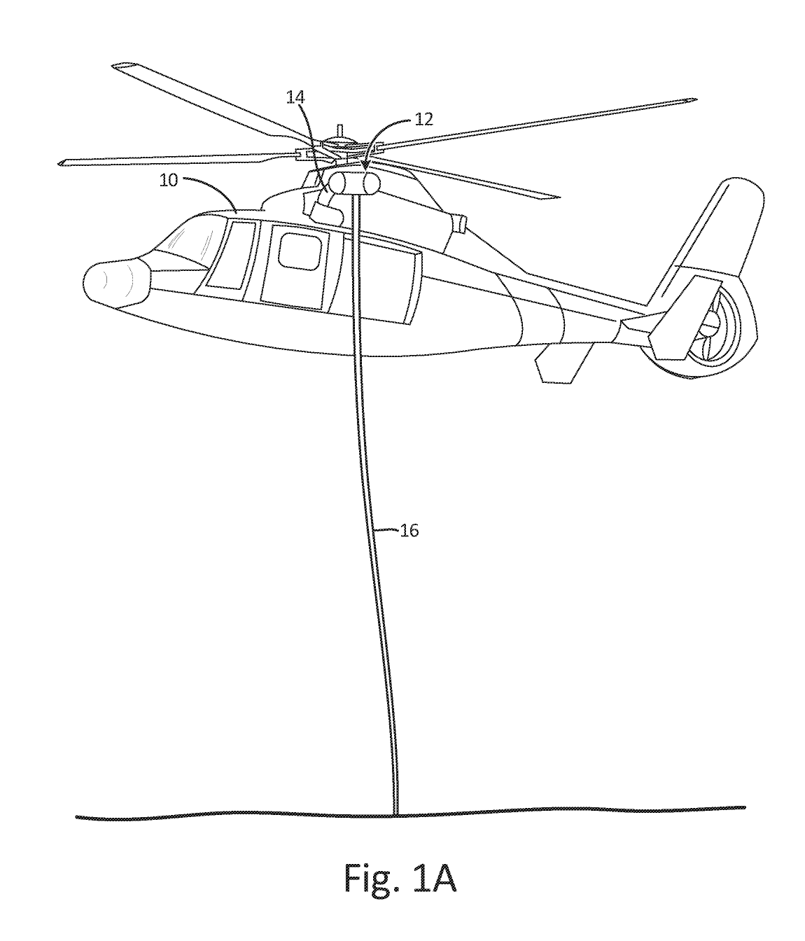

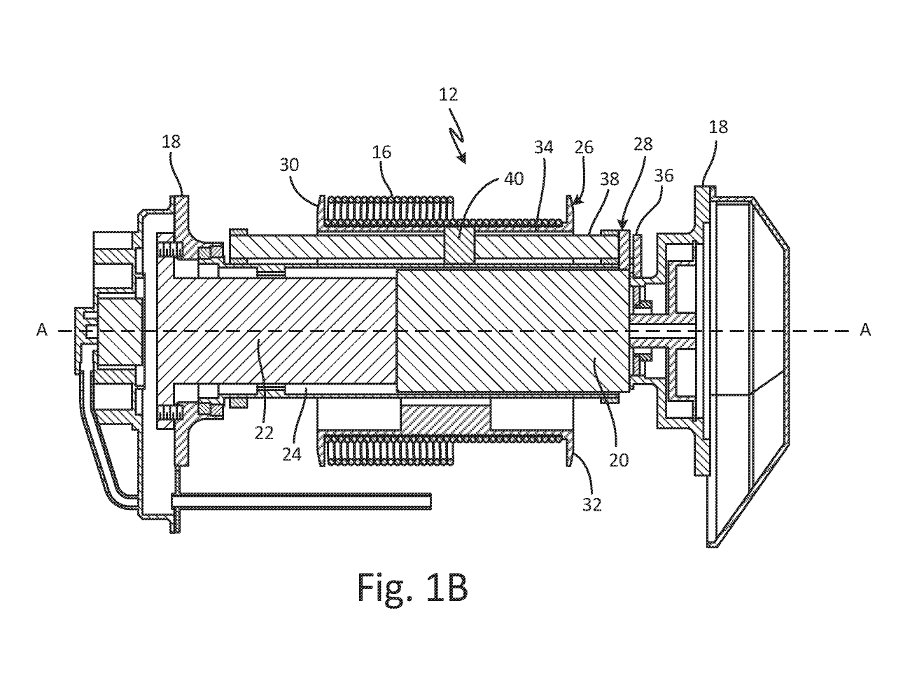

FIG. 1A is an elevation view of aircraft 10 and rescue hoist 12. FIG. 1B is a cross-sectional view of rescue hoist 12. FIGS. 1A and 1B will be discussed together. Rescue hoist 12 is mounted to aircraft 10 by support 14, and cable 16 extends from rescue hoist 12. Rescue hoist 12 includes frame 18, motor 20, drive train 22, linear bearing 24, cable drum 26, and level wind mechanism 28. Cable drum 26 includes first flange 30, second flange 32, and barrel 34. Barrel 34 extends between and connects first flange 30 and second flange 32. Level wind mechanism 28 includes main drive gear 36, screws 38, and traveling block 40.

Rescue hoist 12 is mounted to aircraft 10 by support 14. Cable 16 extends from rescue hoist 12 and is configured to raise and lower objects to and from aircraft 10. Linear bearing 24 is rotatably mounted to frame 18. Motor 20 extends from frame 18 and is disposed within linear bearing 24. Drive train 22 is connected to motor 20 and linear bearing 24, and drive train 22 is configured to transmit rotational power from motor 20 to linear bearing 24. Cable drum 26 is mounted to linear bearing 24. Level wind mechanism 28 is also mounted to linear bearing 24 and extends through cable drum 26. Cable 16 wraps around barrel 34 of cable drum 26 and is retained between first flange 30 and second flange 32.

During operation, motor 20 is activated and provides rotational power to drive train 22. Drive train 22 is a gear reduction drive, and drive train 22 outputs rotational power to linear bearing 24, thereby causing linear bearing 24 to rotate about cable drum axis A-A. In one embodiment, linear bearing 24 is a ball spline bearing, and as such linear bearing 24 is capable of transmitting torque to cable drum 26 to thereby cause cable drum to rotate about cable drum axis A-A to spool cable 16 onto cable drum 26 or unspool cable 16 from cable drum 26.

Level wind mechanism 28 is mounted to linear bearing 24 such that level wind mechanism 28 rotates about cable drum axis A-A with linear bearing 24. Main drive gear 36 is attached to screw 38 and is meshed with teeth on a housing of motor 20. Because the housing of motor 20 remains stationary as linear bearing 24 rotates, rotating linear bearing 24 causes main drive gear 36 to rotate due to main drive gear 36 meshing with the teeth on the housing of motor 20. Main drive gear 36 transmits the resulting rotational power to screw 38, thereby causing screw 38 to rotate. Traveling block 40 is mounted to cable drum 26 and tracks along screw 38 as screw 38 rotates, thereby causing cable drum 26 to translate along cable drum axis A-A due to the connection of traveling block 40 and cable drum 26. Cable drum 26 translates along cable drum axis A-A to allow cable 16 to be paid out through a single point on rescue hoist 12.

While rescue hoist 12 is described as including cable drum 26 that translates along cable drum axis A-A, it is understood that cable drum 26 can be fixed such that cable drum 26 does not translate along cable drum axis A-A. Where cable drum 26 does not translate, rescue hoist includes a translating payout point. Drive train 22 can be directly meshed with barrel 34 of cable drum 26 to cause cable drum 26 to rotate about cable drum axis A-A. Level wind mechanism 28 is meshed with a payout mechanism through which cable 16 extends. Level wind mechanism 28 rotates with cable drum 26 and causes a follower to translate relative to cable drum 26. Cable 16 is paid out and retrieved through a follower. The follower translates relative to cable drum 26 to ensure that cable 16 is levelly wound onto and off of cable drum 26. To ensure level winding of cable 16, the follower is connected to screw 38 of level wind mechanism 28. While level wind mechanism 28 is shown extending through cable drum 26, it is understood that level wind mechanism 28 can also be mounted outside of cable drum 26.

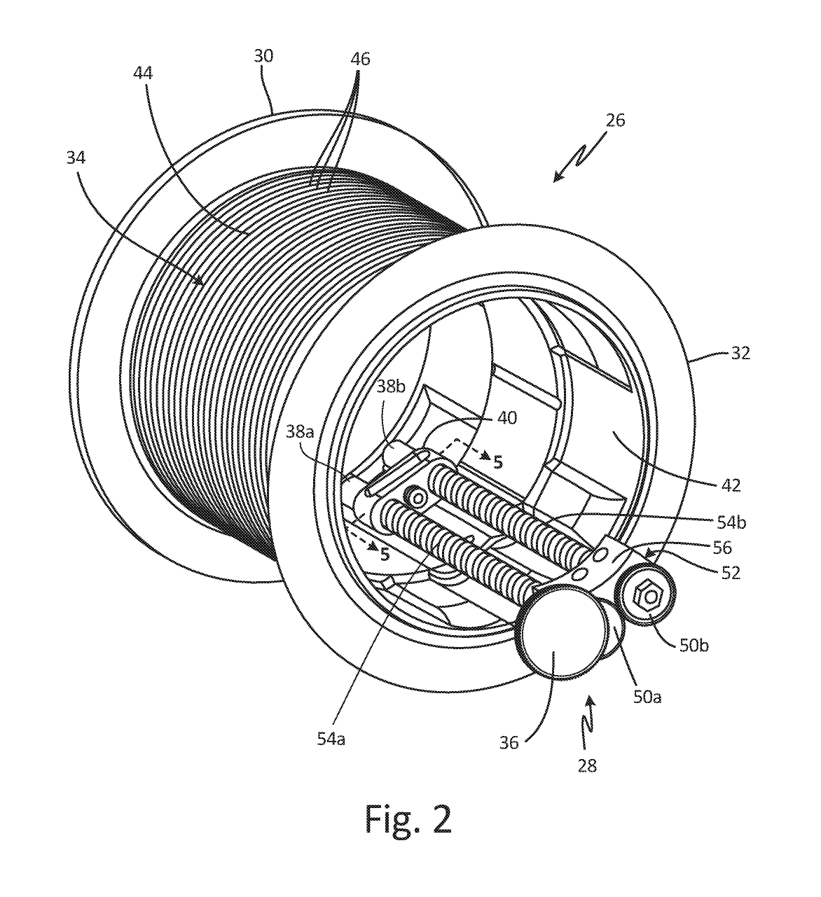

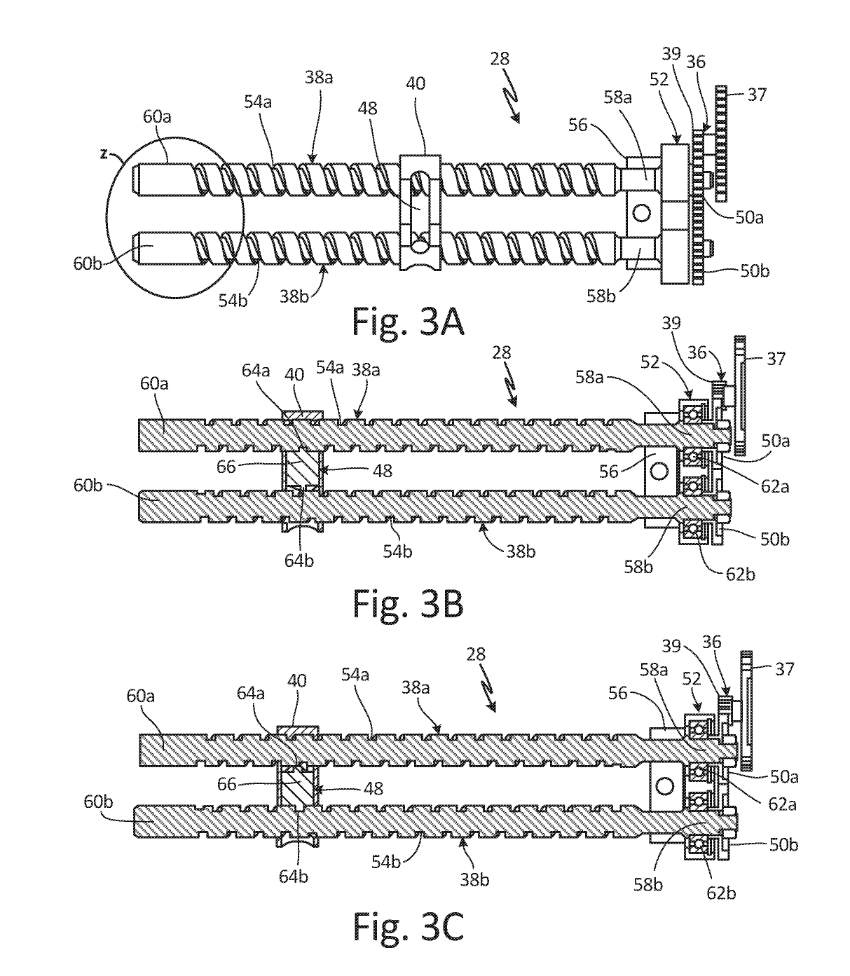

FIG. 2 is a perspective view of cable drum 26 and level wind mechanism 28. Cable drum 26 includes first flange 30, second flange 32, and barrel 34. Barrel 34 includes inner surface 42 and outer surface 44. Outer surface 44 includes grooves 46. Level wind mechanism 28 includes main drive gear 36, first screw 38a, second screw 38b, traveling block 40, shoe 48 (shown in FIGS. 3A-5B), first drive gear 50a, second drive gear 50b, and mount 52. First screw 38a includes first thread 54a and second screw 38b includes second thread 54b. Mount 52 includes mounting flange 56.

Barrel 34 extends between and connects first flange 30 and second flange 32. Grooves 46 extend about outer surface 44 of barrel 34 and are configured to maintain a position of cable 16 (shown in FIG. 1) on barrel 34. Traveling block 40 is connected to inner surface 42 of barrel 34. Mount 52 is attached to linear bearing 24 (shown in FIG. 1B) by mounting flange 56 and as such, mount 52 rotates about cable drum axis A-A along with linear bearing 24. Linear bearing 24 extends through cable drum 26 and transmits torque to cable drum 26, thereby causing cable drum 26 to rotate about cable drum axis A-A. For example, linear bearing 24 can be a ball spline bearing.

First screw 38a extends through mount 52 and is connected to first drive gear 50a. Similarly, second screw 38b extends through mount 52 and is connected to second drive gear 50b. First thread 54a extends along first screw 38a and second thread 54b extends along second screw 38b. In one embodiment, first thread 54a and second thread 54b have an Acme thread form, but it is understood that first thread 54a and second thread 54b can take any desired form, such as a trapezoidal thread form other than an acme thread, a square thread form, or any other desired thread form. In one embodiment, first screw 38a is identical to second screw 38b. As such, in one embodiment first thread 54a is a right-hand thread and second thread 54b is also a right-hand thread. In another embodiment, first thread 54a is a left-hand thread and second thread 54b is also a left-hand thread.

Main drive gear 36 is shown as engaging first drive gear 50a, but it is understood that main drive gear 36 can engage first drive gear 50a, second drive gear 50b, or both. Main drive gear 36 can also engage and drive an intermediate gear to transmit power to first drive gear 50a and second drive gear 50b. First drive gear 50a meshes with second drive gear 50b. Directly meshing first drive gear 50a and second drive gear 50b cause first drive gear 50a and second drive gear 50b to rotate in opposite directions and to rotate at the same speed, as first drive gear 50a and second drive gear 50b have the same number of gear teeth in one embodiment. It is understood, however, that an intermediate gear can be positioned between first drive gear 50a and second drive gear 50b to transmit power therebetween and cause first drive gear 50a and second drive gear 50b to rotate in the same direction. Main drive gear 36 can also be positioned between first drive gear 50a and second drive gear 50b to engage both first drive gear 50a and second drive gear 50b and to cause first drive gear 50a and second drive gear 50b to rotate in the same direction. Where first screw 38a and second screw 38b rotate in the same direction, a handedness of first thread 54a differs from a handedness of second thread 54b. The differing handedness allows first thread 54a to drive an object in a first direction and second thread 54b to drive an object in a second direction opposite the first direction while both first screw 38a and second screw 38b rotate in the same direction.

Traveling block 40 is disposed on and attached to inner surface 42 of barrel 34. First screw 38a extends from first drive gear 50a and through traveling block 40. Second screw 38b extends from second drive gear 50b and through traveling block 40. A shoe (shown in FIGS. 3A-3C and 5A-7) is disposed within traveling block 40, and the shoe is configured to shuttle between and engage first thread 54a and second thread 54b. First screw 38a and second screw 38b drive the shoe axially along cable drum axis A-A in a reciprocating manner. The shoe transmits driving force from first screw 38a and second screw 38b to traveling block 40, and traveling block 40 transmits the driving force to cable drum 26, thereby driving cable drum 26 in a reciprocating manner along cable drum axis A-A. Cable drum 26 translates along cable drum axis A-A to ensure that cable 16 is levelly wound onto outer surface 44 of barrel 34. Translating cable drum 26 allows for cable 16 to be paid out from a single point, reducing any stresses that can be caused due to large fleet angles, thereby allowing side loads to be transmitted directly to the frame of the rescue hoist and to the airframe of the aircraft, reducing stress on the components of rescue hoist 12.

During operation motor 20 (shown in FIG. 1B) provides power, either directly or indirectly, such as through drive train 22 (shown in FIG. 1B) or other intermediate transmission, to linear bearing 24 and main drive gear 36. As linear bearing 24 rotates, cable drum 26 and level wind mechanism 28 simultaneously rotate about cable drum axis A-A. The rotation of main drive gear 36 powers first drive gear 50a and second drive gear 50b, thereby causing first screw 38a and second screw 38b to rotate. Due to the direct connection of first drive gear 50a and second drive gear 50b, first screw 38a rotates opposite second screw 38b. Where the shoe is initially engaged with first thread 54a, the shoe is driven along a length of first thread 54a due to the connection of the shoe and first thread 54a. With the shoe captured within traveling block 40, the shoe transmits driving forces from first screw 38a to traveling block 40, and traveling block 40 transmits the driving forces to cable drum 26. As such, cable drum 26 shifts along cable drum axis A-A due to the connection of cable drum 26 to level wind mechanism 28 through traveling block 40.

When the shoe reaches an end of first thread 54a, the shoe translates over and engages second thread 54b of second screw 38b. Because second screw 38b rotates opposite first screw 38a, second screw 38b drives the shoe in an opposite direction than first screw 38a. As such, second screw 38b drives cable drum 26 back along cable drum axis A-A. When the shoe reaches an end of second thread 54b, the shoe translates over and engages first thread 54a. In this way, the shoe and thus cable drum 26 is driven in a reciprocating manner by first screw 38a and second screw 38b. It is understood that both first screw 38a and second screw 38b can drive cable drum 26 in either direction along cable drum axis A-A depending on the direction of rotation of main drive gear 36, and thus of first drive gear 50a and second drive gear 50b. For example, where first screw 38a rotates in a clockwise direction and second screw 38b rotates in a counterclockwise direction to unspool cable 16 from cable drum 26, first screw 38a will rotate in the counterclockwise direction and second screw 38b will rotate in the clockwise direction to spool cable 16 onto cable drum 26. As such, level wind mechanism 28 ensures that cable 16 is levelly wound onto cable drum 26

Translating cable drum 26 along cable drum axis A-A ensures that cable 16 is levelly wound onto cable drum 26. Cable drum 26 displaces axially along cable drum axis A-A to ensure that cable 16 is aligned with a sheave (not shown) as cable 16 unspools from or spools onto cable drum 26. Levelly winding cable 16 helps ensure that cable 16 is properly wound onto and off of cable drum 26.

FIG. 3A is an elevation view of level wind mechanism 28. FIG. 3B is a cross-sectional view of level wind mechanism 28 showing shoe 48 in a first position. FIG. 3C is a cross-sectional view of level wind mechanism 28 showing shoe 48 in a second position. FIGS. 3A-3C will be discussed together. Level wind mechanism 28 includes main drive gear 36, first screw 38a, second screw 38b, traveling block 40, shoe 48, first drive gear 50a, second drive gear 50b, and mount 52. First screw 38a includes first thread 54a, driven end 58a, and distal end 60a. Second screw 38b includes second thread 54b, driven end 58b, and distal end 60b. Mount 52 includes mounting flange 56, bearing 62a, and bearing 62b. Shoe 48 includes first follower 64a, second follower 64b, and shoe body 66. Main drive gear 36 includes input gear 37 and output gear 39.

First screw 38a and second screw 38b extend through and are supported by mount 52. Driven end 58a of first screw 38a extends through mount 52 and is connected to first drive gear 50a. Driven end 58a is rotatably supported within mount 52 by bearing 62a. First thread 54a extends about first screw 38a between driven end 58a and distal end 60a. Driven end 58b of second screw 38b extends through mount 52 and is connected to second drive gear 50b. Driven end 58b is rotatably supported within mount 52 by bearing 62b. Second thread 54b extends about second screw 38b between driven end 58b and distal end 60b. Main drive gear 36 provides rotational power to first drive gear 50a and second drive gear 50b. Output gear 39 is meshed with one or both of first drive gear 50a and second drive gear 50b. Input gear 37 is meshed with teeth on frame 18 (shown in FIG. 1B), such that rotating level wind mechanism 28 about cable drum axis A-A with linear bearing 24 (shown in FIG. 1B) causes main drive gear 36 to rotate.

First thread 54a can be a right-hand thread or a left-hand thread. Similarly, second thread 54b can be a right-hand thread or a left-hand thread. In an embodiment where first thread 54a is a right-hand thread, second thread 54b is also a right-hand thread. With both first thread 54a and second thread 54b having the same handedness, first screw 38a is identical to second screw 38b, thereby simplifying both the manufacturing and assembly process and reducing the material costs associated with level wind mechanism 28.

Shoe 48 is disposed within traveling block 40 between first screw 38a and second screw 38b. First follower 64a extends from an end of shoe body 66, and second follower 64b extends from an end of shoe body 66 opposite first follower 64a. First follower 64a is configured to engage with and track along first thread 54a as first screw 38a rotates. Similarly, second follower 64b is configured to engage with and track along second thread 54b as second screw 38b rotates. In one embodiment, shoe body 66 is cylindrical, thereby allowing shoe 48 to rotate relative to traveling block 40. Enabling shoe 48 to rotate relative to traveling block 40 ensures that first follower 64a is properly aligned with first thread 54a when shoe 48 translates to engage first thread 54a, and ensures that second follower 64b is properly aligned with second thread 54b when shoe 48 translates to engage second thread 54b.

During operation, main drive gear 36 provides rotational power to first drive gear 50a and second drive gear 50b. In one embodiment, first drive gear 50a and second drive gear 50b are identical, such that first drive gear 50a and second drive gear 50b have the same rotational speed. Because the teeth of first drive gear 50a are intermeshed with the teeth of second drive gear 50b, first drive gear 50a and second drive gear 50b rotate in opposite directions. First screw 38a thus rotates opposite second screw 38b.

In FIG. 3B, first follower 64a is engaged with first thread 54a. As first screw 38a rotates, first follower 64a tracks along first thread 54a thereby causing shoe 48 to displace axially along first screw 38a. Because shoe 48 is retained within traveling block 40, displacing shoe 48 relative to first screw 38 also causes traveling block 40 to displace relative to first screw 38, thereby causing cable drum 26 to translate relative to level wind mechanism 28. When first follower 64a reaches an end of first thread 54a, first thread 54a pushes first follower 64a out of first thread 54a, thereby driving shoe 48 towards second screw 38b. Shoe 48 translates within traveling block 40 and second follower 64b engages second thread 54b.

In FIG. 3C, second follower 64b is engaged with second thread 54b. As second screw 38b rotates, second follower 64b tracks along second thread 54b thereby causing shoe 48 to displace axially along second screw 38b. Because shoe 48 is retained within traveling block 40, displacing shoe 48 relative to second screw 38b causes traveling block 40 to displace relative to second screw 38b, thereby causing cable drum 26 to translate relative to level wind mechanism 28. When second follower 64b reaches an end of second thread 54b, second thread 54b pushed second follower 64b out of second thread 54b, thereby driving shoe 48 towards first screw 38a.

First screw 38a and second screw 38b drive shoe 48 in opposite axial directions due to first screw 38a rotating in an opposite direction from second screw 38b. It is understood, however, that each of first screw 38a and second screw 38b can displace cable drum 26 in either axial direction, depending on the rotational input from main drive gear 36. Main drive gear 36 rotates in a first rotational direction when unspooling cable 16 from cable drum 26 and main drive gear 36 rotates in a second rotational direction when spooling cable 16 back onto the cable drum 26. In this way, level wind mechanism 28 ensures that cable 16 is levelly wound and unwound from cable drum 26.

Level wind mechanism 28 provides significant advantages. In one embodiment, first screw 38a and second screw 38b are identical and mounted to rotate in opposite directions. Having first screw 38a identical to second screw 38b simplifies the manufacturing process, as only a single part number and configuration is required to supply both first screw 38a and second screw 38b. In addition, each of first thread 54a and second thread 54b is the only thread on first screw 38a and second screw 38b, respectively. As such, neither first screw 38a nor second screw 38b is a self-reversing screw that includes both right-hand and left-hand threads. By eliminating self-reversing screws from level wind mechanism 28, sharp points, where the differing threads intersect, are eliminated Eliminating the sharp points increases the resiliency and lifespan of level wind mechanism 28.

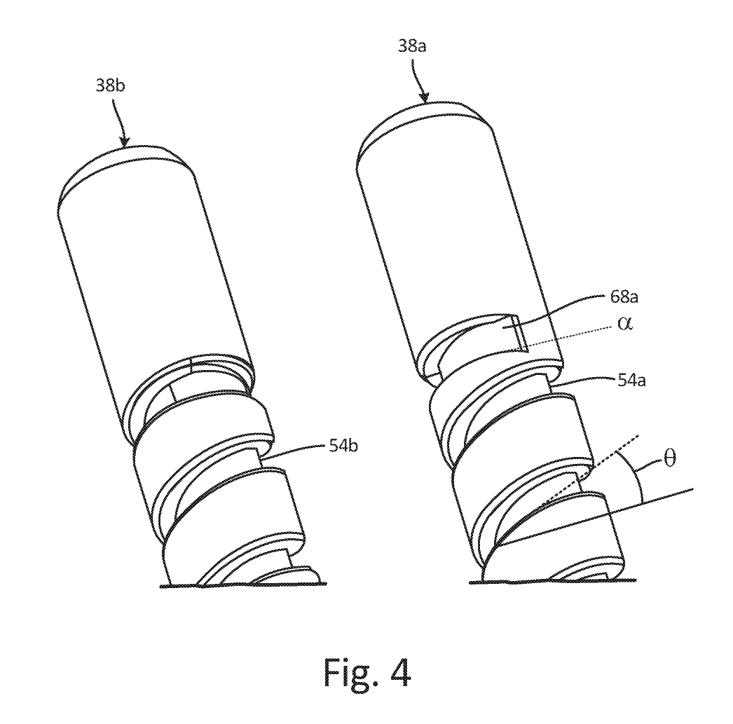

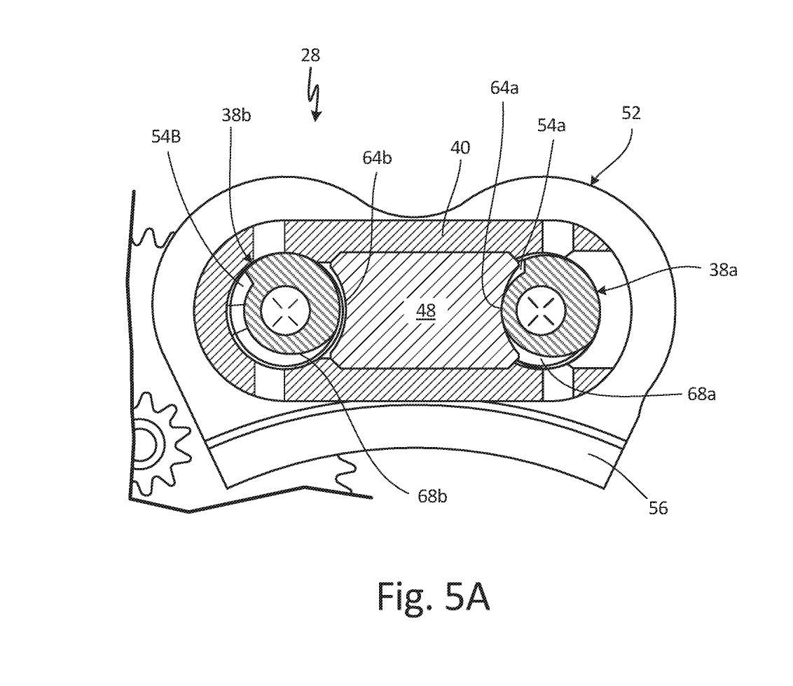

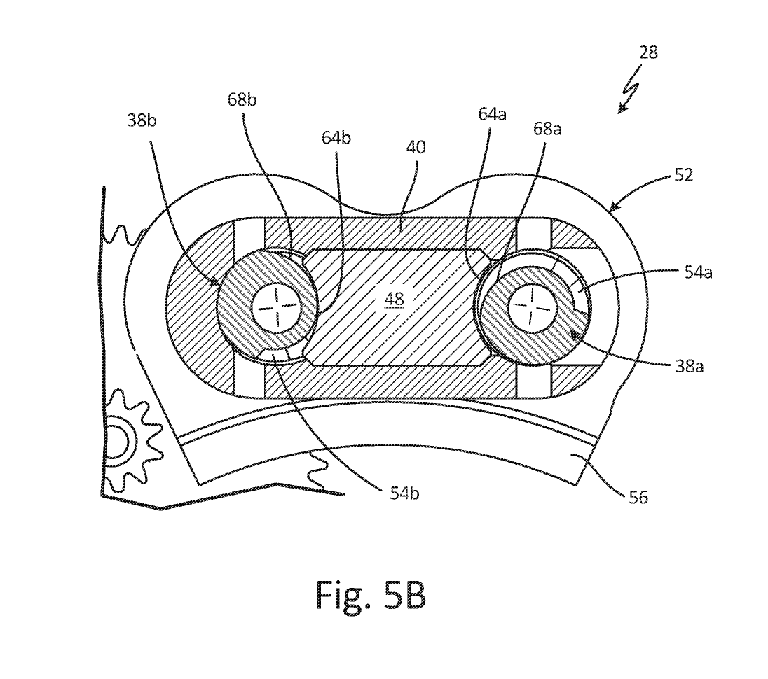

FIG. 4 is a perspective view of detail Z of FIG. 3A. First screw 38a includes first thread 54a, and first thread 54a includes cam 68a. Second screw 38b includes second thread 54b, and second thread 54b similarly includes cam 68b (described in detail below and shown in FIGS. 5A-5B).

First thread 54a extends about first screw 38a and cam 68a is disposed at each end of first thread 54a. As first thread 54a approaches a terminal end the depth of first thread 54a decreases to form cam 68a. First thread 54a generally has a helix angle θ. The terminal ends of first thread 54a, including cam 68a, have a helix angle α that is smaller than the helix angle θ. Helix angle α is preferably about zero degrees such that cam 68a is generally perpendicular to a rotational axis of first screw 38a.

Second thread 54b extends about second screw 38b, and cam 68b is disposed at each end of second thread 54b. As second thread 54b approaches a terminal end of second thread 54b, the depth of second thread 54b decreases to form cam 68b. Similar to first thread 54a, second thread 54b generally has helix angle θ. The terminal ends of second thread 54b, including cam 68b, have a helix angle α that is smaller than the helix angle θ. Helix angle α is preferably about zero degrees such that cam 68b is generally perpendicular to a rotational axis of second screw 38b.

Providing a decreased helix angle α at the terminal end of first thread 54a and second thread 54b aligns shoe 48 during a changeover from engaging one of first screw 38a and second screw 38b to engaging the other one of first screw 38a and second screw 38b. As discussed below with regard to FIGS. 5A and 5B, first follower 64a is clocked relative to second follower 64b in one embodiment. To clock first follower 64a relative to second follower 64a, first follower 64a is rotated out of the same plane as second follower 64b. In one embodiment, first follower 64a is clocked about 10-15 degrees relative to second follower 64b. With first follower 64a clocked relative to second follower 64b, shoe 48 is prevented from changing over. The reduced helix angle α causes shoe 48 to rotate within traveling block 40 (best seen in FIGS. 3A-3C) and aligns shoe 48 to transition during a changeover. For example, as first follower 64a approaches the terminal end of first thread 54a, first follower 64a encounters cam 68a. Cam 68a pushes first follower 64a out of first thread 54a, and the reduced helix angle α causes shoe 48 to rotate as first follower 64a proceeds along cam 68a. Rotating shoe 48 aligns second follower 64b with second thread 54b, and second follower 64b transitions into and engages second thread 54b. With second follower 64b engaging second thread 54b, shoe 48 has completed the changeover and will be driven along second screw 38b. In some embodiments, first follower 64a is clocked by an amount equal to the helix angle θ. For example, where first follower 64a is clocked relative to second follower 64b by an amount equal to the helix angle θ, when first follower 64a is engaged with first thread 54a, second follower 64b will be disposed cross-wise to second thread 54b by an amount equal to twice the helix angle θ, preventing second follower 64b from falling into second thread 54b.

The reduced helix angle α at cam 68a and cam 68b also controls a dwell time of cable drum 26 (best seen in FIG. 2). The dwell time is the period of time where cable drum 26 rotates about the cable drum axis A-A (shown in FIG. 2) but does not translate along cable drum axis A-A. Where cam 68a and cam 68b are relatively short, the dwell time is correspondingly short. Where cam 68a and cam 68b are relatively longer, the dwell time is correspondingly longer.

FIG. 5A is a cross-sectional view of level wind mechanism 28 taken along line 5-5 in FIG. 2 showing shoe 48 in a first position. FIG. 5B is a cross-sectional view of level wind mechanism 28 taken along line 5-5 in FIG. 2 showing shoe 48 in a second position. First screw 38a, second screw 38b, shoe 48, and mount 52 of level wind mechanism 28 are shown. First screw 38a includes first thread 54a, and first thread 54a includes cam 68a. Second screw 38b includes second thread 54b, and second thread 54b includes cam 68b. Shoe 48 includes first follower 64a and second follower 64b.

First screw 38a extends from mount 52 and extends through traveling block 40. Similarly, second screw 38b extends from mount 52 and extends through traveling block 40. First thread 54a extends about first screw 38a, and cam 68a is disposed at a terminal end of first thread 54a. Cam 68a is a decreasing depth of first thread 54a as first thread 54a reaches the terminal end. While cam 68a is shown at one terminal end of first thread 54a, it is understood that each terminal end of first thread 54a includes cam 68a. Second thread 54b extends about second screw 38b, and cam 68b is disposed at a terminal end of second thread 54b. Cam 68b is a decreasing depth of second thread 54b as second thread 54b reaches the terminal end. While cam 68b is shown at one terminal end of second thread 54b, it is understood that each terminal end of second thread 54b includes cam 68b.

Shoe 48 is disposed within traveling block 40 between first screw 38a and second screw 38b. First follower 64a extends from a first end of shoe body 66 and second follower 64b extends from a second end of shoe body 66 opposite the first end. First follower 64a is configured to engage with and be driven by first thread 54a. Similarly, second follower 64b is configured to engage with and be driven by second thread 54b.

During operation, first follower 64a tracks along first thread 54a until first follower 64a reaches cam 68a. When first follower 64a reaches cam 68a, cam 68a lifts first follower 64a out of first thread 54a, thereby causing shoe 48 to shift from engaging first screw 38a to engaging second screw 38b. Shifting shoe 48 causes second follower 64b to engage second thread 54b, and shoe 48 is then driven along second thread 54b. When second follower 64b reaches cam 68b, cam 68b lifts second follower 64b out of second thread 54b, thereby causing shoe 48 to shift from engaging second screw 38b to engaging first screw 38a. In this way, cam 68a and cam 68b ensure that shoe 48 translates between first screw 38a and second screw 38b, thereby driving cable drum 26 (best seen in FIG. 2) in a reciprocating manner.

Cam 68a causes shoe 48 to disengage from first screw 38a and displace to engage with second screw 38b. For example, in FIG. 5A, first follower 64a is disposed within first thread 54a. Where first screw 38a rotates in the clockwise direction second screw 38b preferably rotates in the counterclockwise direction. As first screw 38a rotates in the clockwise direction, first follower 64a tracks along first thread 54a and encounters cam 68a. Cam 68a lifts first follower 64a relative to first screw 38a, thereby causing shoe 48 to shift from the position shown in FIG. 5A to the position shown in FIG. 5B, with second follower 64b engaging second thread 54b. Second screw 38b then drives shoe 48 back along second screw 38b due to second screw 38b rotating in the opposite direction of first screw 38a.

Cam 68b causes shoe 48 to disengage from second screw 38 and displace to engage with first screw 38a. For example, in FIG. 5B, second follower 64b is disposed within second thread 54. Where second screw 38b rotates in the clockwise direction first screw 38a preferably rotates in the counterclockwise direction. As second screw 38b rotates in the clockwise direction, second follower 64b tracks along second thread 54b and encounters cam 68b. Cam 68b lifts second follower 64b relative to second screw 38b, thereby causing shoe 48 to shift from the position shown in FIG. 5B to the position shown in FIG. 5A, with first follower 64a engaging first thread 54a. First screw 38a then drives shoe 48 back along first screw 38a due to first screw 38a rotating in the opposite direction of second screw 38b.

It is understood that both ends of first thread 54a include cam 68a. In this way, both ends of first thread 54a are able to displace first follower 64a from first thread 54a to cause shoe 48 to change over to engaging second screw 38b. Similarly, both ends of second thread 54b include cam 68b, so both ends of second thread 54b are able to displace second follower 64b from second thread 54b, thereby causing shoe 48 to shift to engaging first screw 38a. As such, first screw 38a and second screw 38b are configured to affect the changeover of shoe 48 regardless of the direction of travel of shoe 48 and regardless of the direction of rotation of first screw 38a and second screw 38b.

Level wind mechanism 28 provides significant advantages. Each of first screw 38a and second screw 38b includes a single thread that causes shoe 48 to displace along first screw 38a and second screw 38b. The single thread prevents shoe 48 from prematurely reversing direction on first screw 38a or second screw 38b. Moreover, a single thread provides a more robust screw, thereby increasing the lifespan of the components of level wind mechanism 28.

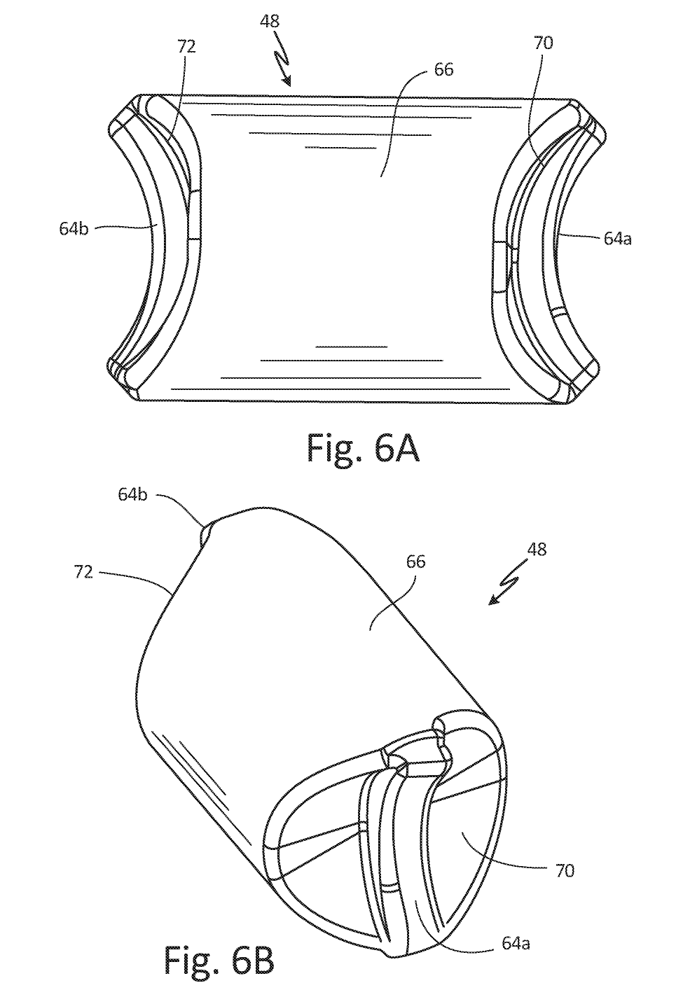

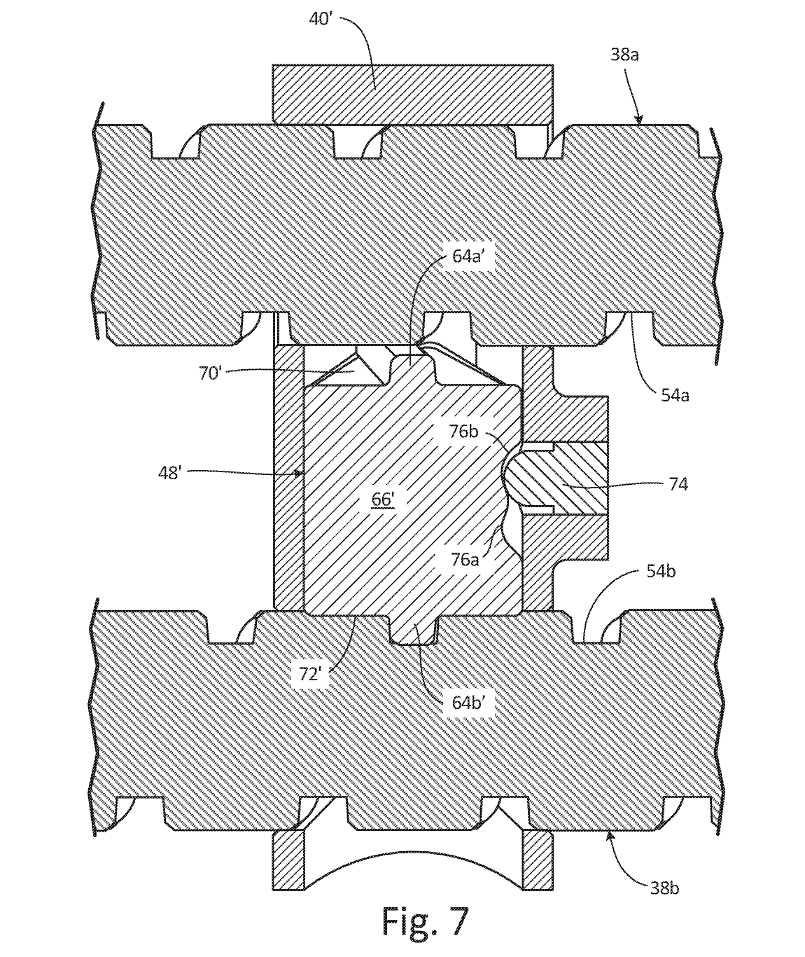

FIG. 6A is a side elevation view of shoe 48. FIG. 6B is a perspective view of shoe 48. FIGS. 6A and 6B will be discussed together. Shoe 48 includes shoe body 66, first end 70, and second end 72. First end 70 includes first follower 64a. Second end 72 includes second follower 64b.

First end 70 and second end 72 are arcuate. First end 70 is arcuate to match a contour of first screw 38a. Second end 72 is arcuate to match a contour of second screw 38b. First follower 64a extends from first end 70, and second follower 64b extends from second end 72. First follower 64a extends across a full diameter of first end 70. First follower 64a is helically curved to match the contour of first thread 54a (best seen in FIGS. 3A-3C). Curving first follower 64a provides a maximum contact area between first follower 64a and first screw 38a, thereby providing smoother, more efficient driving of first follower 64a within first thread 54a. Similarly, second follower 64b extends across a full diameter of second end 72, and second follower 64b is helically curved to match the contour of second thread 54b (best seen in FIGS. 3A-3C). Curving second follower 64b provides a maximum contact area between second follower 64a and second screw 38b, thereby providing smoother, more efficient driving of second follower 64b within second thread 54b. While first follower 64a and second follower 64b are described as being helically curved and as extending across a full diameter of shoe 48, it is understood that first follower 64a and second follower 64b can take any desired shape or size. For example, first follower 64a and second follower 64b can be a pin or head extending from first end 70 and second end 72, respectively. First follower 64a and second follower 64b can also be straight bars configured to fit into first thread 54a and second thread 54b, respectively.

First follower 64a is clocked relative to second follower 64b such that first follower 64a and second follower 64b are not on the same vertical plane passing through shoe 48. Clocking first follower 64a relative to second follower 64b helps prevent shoe 48 from prematurely shifting from engaging first screw 38a to engaging second screw 38b. By clocking first follower 64a relative to second follower 64b, second follower 64b is misaligned with second thread 54b and thus unable to fall into second thread 54b as first follower 64a tracks along first thread 54a. In this way, the clocking of first follower 64a and second follower 64b ensures that shoe 48 does not translate from first screw 38a to second screw 38b or from second screw 38b to first screw 38a prior to reaching the changeover point at the terminal ends of first thread 54a and second thread 54b.

FIG. 7 is a cross-sectional view of level wind mechanism 28 having an alternate embodiment of shoe 48′ and traveling block 40′. First screw 38a includes first thread 54a. Second screw 38b includes second thread 54b. Shoe 48′ includes shoe body 66′, first end 70′, and second end 72′. First end 70′ includes first follower 64a′. Second end 72′ includes second follower 64b′. Shoe body 66′ includes first depression 76a and second depression 76b. Traveling block 40′ includes detent 74.

First thread 54a extends about first screw 38a, and first screw 38a extends through traveling block 40′. Second thread 54b extends about second screw 38b, and second screw 38b extends through traveling block 40′. Shoe 48′ is disposed within traveling block 40′ between first screw 38a and second screw 38b.

First end 70′ of shoe 48′ is arcuate to match the contour of first screw 38a. First follower 64a′ extends from first end 70′ and is configured to engage first thread 54a. Second end 72′ of shoe 48′ is arcuate to match the contour of second screw 38b. Second follower 64b′ extends from second end 72′ and is configured to engage second thread 54b. Shoe body 66′ extends between and connects first end 70′ and second end 72′. First depression 76a and second depression 76b extend into shoe body 66′. Detent 74 is retained by traveling block 40′ and extends into traveling block 40′ to alternatingly engage first depression 76a and second depression 76b. In one embodiment, detent 74 is of a spring and ball configuration, but it is understood that detent 74 can be any suitable device for resisting movement of shoe 48′, such as spring steel or other spring-loaded pin.

During operation, first screw 38a and second screw 38b drive shoe 48′ in a reciprocating manner. First follower 64a′ engages first thread 54a and is driven along first thread 54a by the rotation of first screw 38a. Similarly, second follower 64b′ engages second thread 54b and is driven along second thread 54b by the rotation of second screw 38b.

With first follower 64a′ engaging first thread 54a, detent 74 is disposed in and engages first depression 76a. Detent 74 engaging first depression 76a maintains first follower 64a′ in first thread 54a as first follower 64a′ tracks along first thread 54a. As such, detent 74 prevents first follower 64a′ from prematurely disengaging from first thread 54a, thereby preventing shoe 48′ from prematurely changing over. When first follower 64a′ reaches an end of first thread 54a, first thread 54a pushes first follower 64a′ out of an engagement with first thread 54a and causes shoe 48′ to shift within traveling block 40′ until second follower 64b′ engages second thread 54b. As shoe 48′ shifts within traveling block 40′, detent 74 is depressed by shoe 48′, thereby allowing shoe 48′ to transition to engaging second screw 38b. When second follower 64b′ is engaged with second thread 54b, detent 74 snaps into place in second depression 76b. Detent 74 then maintains the position of shoe 48′ such that second follower 64b′ remains engaged with second thread 54b until a changeover of shoe 48′ is desired. As such, detent 74 prevents shoe 48′ from prematurely disengaged from first screw 38a or second screw 38b. Detent 74 thus allows first follower 64a′ to be disposed in the same plane as second follower 64b′ while still preventing any premature changeover. Detent 74 also reduces vibrations experienced by shoe 48′ and by first screw 38a and second screw 38b by holding shoe 48′ steady relative to first screw 38a and second screw 38b.

### Discussion of Possible Embodiments

The following are non-exclusive descriptions of possible embodiments of the present invention.

A level wind mechanism includes a first screw, a second screw, a block through which the first screw and the second screw extend, and a shoe retained within the block between the first screw and the second screw. The first screw has a first driven end, a first distal end, and a first thread. The second screw has a second driven end, a second distal end, and a second thread. The shoe has a first follower extending from a first end of the shoe and a second follower extending from a second end of the shoe. The first follower is configured to engage with and be driven by the first thread and the second follower is configured to engage with and be driven by the second thread.

The level wind mechanism of the preceding paragraph can optionally include, additionally and/or alternatively, any one or more of the following features, configurations and/or additional components:

The first thread includes a first cam disposed at a first terminal end of the first thread and a second cam disposed at a second terminal end of the first thread.

The first thread has a first helix angle and the first cam has a second helix angle, the second helix angle is smaller than the first helix angle.

The second helix angle is about zero degrees.

A mount extending around and supporting the first driven end and the second driven end, a first drive gear attached to the first driven end, and a second drive gear attached to the second driven end.

The first drive gear is meshed with the second drive gear such that the first drive gear is configured to rotate opposite the second drive gear.

A first bearing disposed in the mount and supporting the first driven end, and a second bearing disposed in the mount and supporting the second driven end.

The first follower comprises a first curved ridge projecting from the first end of the shoe, and the second follower comprises a second curved ridge projecting from the second end of the shoe.

The first end is concavely curved and the second end is concavely curved.

The first thread has a first handedness and the second thread has a second handedness, and wherein the first handedness is the same as the second handedness.

A rescue hoist includes a cable drum rotatable about a cable drum axis, a linear bearing extending through and supporting the cable drum and configured to cause the cable drum to rotate about the cable drum axis, a stationary frame supporting the linear bearing, and a level wind mechanism configured to cause the cable drum to translate along the cable drum axis. The level wind mechanism includes a first screw, a second screw, a block through which the first screw and the second screw extend, and a shoe retained within the block between the first screw and the second screw. The first screw has a first driven end, a first distal end, and a first thread.

The second screw has a second driven end, a second distal end, and a second thread. The block is mounted on an inner surface of the cable drum. The shoe has a first follower extending from a first end of the shoe and a second follower extending from a second end of the shoe. The first follower is configured to engage with and be driven by the first thread and the second follower is configured to engage with and be driven by the second thread.

The rescue hoist of the preceding paragraph can optionally include, additionally and/or alternatively, any one or more of the following features, configurations and/or additional components:

The first thread includes a first cam disposed at a first terminal end of the first thread and a second cam disposed at a second terminal end of the first thread.

The first thread has a first helix angle and the first cam has a second helix angle, wherein the second helix angle is smaller than the first helix angle.

The level wind mechanism includes a mount extending around and supporting the first driven end and the second driven end, the mount attached to the linear bearing such that the level wind mechanism rotates about the cable drum axis with the linear bearing and the cable drum.

A first drive gear attached to the first driven end, a second drive gear attached to the second driven end, and a main drive gear connected to and driving at least one of the first drive gear and the second drive gear.

The main drive gear includes an input gear meshing with teeth on the stationary frame.

The first drive gear meshes with the second drive gear.

The first follower comprises a first curved ridge projecting from the first end of the shoe, and the second follower comprises a second curved ridge projecting from the second end of the shoe.

The first end is concavely curved and the second end is concavely curved.

The first thread has a first handedness and the second thread has a second handedness, and wherein the first handedness is the same as the second handedness.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A level wind mechanism comprising:
a first screw including a first driven end, a first distal end, and a first thread;
a second screw including a second driven end, a second distal end, and a second thread;
a block through which the first screw and the second screw extend; and
a shoe retained within the block, the shoe having a first follower extending from a first end of the shoe and a second follower extending from a second end of the shoe, the first follower configured to engage with and be driven by the first thread and the second follower configured to engage with and be driven by the second thread.

2. The level wind mechanism of claim 1, wherein the first thread includes a first cam disposed at a first terminal end of the first thread and a second cam disposed at a second terminal end of the first thread.

3. The level wind mechanism of claim 2, wherein the first thread has a first helix angle and the first cam has a second helix angle, wherein the second helix angle is smaller than the first helix angle.

4. The level wind mechanism of claim 3, wherein the second helix angle is zero degrees.

5. The level wind mechanism of claim 1, further comprising:
a mount extending around and supporting the first driven end and the second driven end;
a first drive gear attached to the first driven end; and
a second drive gear attached to the second driven end.

6. The level wind mechanism of claim 5, wherein the first drive gear is meshed with the second drive gear such that the first drive gear is configured to rotate opposite the second drive gear.

7. The level wind mechanism of claim 5, further comprising:
a first bearing disposed in the mount and supporting the first driven end; and
a second bearing disposed in the mount and supporting the second driven end.

8. The level wind mechanism of claim 1, wherein:
the first follower comprises a first curved ridge projecting from the first end of the shoe; and
the second follower comprises a second curved ridge projecting from the second end of the shoe.

9. The level wind mechanism of claim 8, wherein the first end is concavely curved and the second end is concavely curved.

10. The level wind mechanism of claim 1, wherein the first thread has a first handedness and the second thread has a second handedness, and wherein the first handedness is the same as the second handedness.

11. A rescue hoist comprising:
a cable drum rotatable about a cable drum axis;
a linear bearing extending through and supporting the cable drum, the linear bearing configured to cause the cable drum to rotate about the cable drum axis;
a stationary frame supporting the linear bearing; and
a level wind mechanism configured to cause the cable drum to translate along the cable drum axis, the level wind mechanism comprising:
a first screw including a first driven end, a first distal end, and a first thread;
a second screw including a second driven end, a second distal end, and a second thread;
a block through which the first screw and the second screw extend, the block mounted on an inner surface of the cable drum; and
a shoe retained within the block, the shoe having a first follower extending from a first end of the shoe and a second follower extending from a second end of the shoe, the first follower configured to engage with and be driven by the first thread thereby driving the shoe relative to the first screw and the second follower configured to engage with and be driven by the second thread thereby driving the shoe relative to the second screw.

12. The rescue hoist of claim 11, wherein the first thread includes a first cam disposed at a first terminal end of the first thread and a second cam disposed at a second terminal end of the first thread.

13. The rescue hoist of claim 12, wherein the first thread has a first helix angle and the first cam has a second helix angle, wherein the second helix angle is smaller than the first helix angle.

14. The rescue hoist of claim 11, wherein the level wind mechanism further comprises:
a mount extending around and supporting the first driven end and the second driven end, the mount attached to the linear bearing such that the level wind mechanism rotates about the cable drum axis with the linear bearing and the cable drum.

15. The rescue hoist of claim 14, further comprising:
a first drive gear attached to the first driven end;
a second drive gear attached to the second driven end; and
a main drive gear connected to and driving at least one of the first drive gear and the second drive gear.

16. The rescue hoist of claim 15, wherein the main drive gear includes an input gear meshing with teeth on the stationary frame.

17. The rescue hoist of claim 15, wherein the first drive gear meshes with the second drive gear.

18. The rescue hoist of claim 11, wherein:
the first follower comprises a first curved ridge projecting from the first end of the shoe; and
the second follower comprises a second curved ridge projecting from the second end of the shoe.

19. The rescue hoist of claim 18, wherein the first end is concavely curved and the second end is concavely curved.

20. The rescue hoist of claim 11, wherein the first thread has a first handedness and the second thread has a second handedness, and wherein the first handedness is the same as the second handedness.
